(19) United States
(12) Patent Application Publication
(10) Pub. No.: US 2015/0247972 A1
(43) Pub. Date: Sep. 3, 2015

(54) OPTICAL FIBER, FIBER LASER, AND OPTICAL FIBER MANUFACTURING METHOD

(71) Applicant: PANASONIC CORPORATION, OSAKA (JP)

(72) Inventor: Hideaki ITOH, Hyogo (JP)

(73) Assignee: PANASONIC CORPORATION, OSAKA (JP)

(21) Appl. No.: 14/215,327

(22) Filed: Mar. 17, 2014

Related U.S. Application Data
(63) Continuation of application No. PCT/JP2012/005826, filed on Sep. 13, 2012.

(30) Foreign Application Priority Data
Sep. 20, 2011 (JP) 2011-204089

(51) Int. Cl. G02B 6/255; H01S 3/067; H01S 3/094; G02B 6/02

(52) U.S. Cl. CPC G02B 6/255; G02B 6/02076; H01S 3/0675; H01S 3/094042; G02B 6/02123

(57) ABSTRACT

An optical fiber of the present invention includes an uncoated FBG fiber in which an FBG mirror is written in a core glass, a first optical fiber that is spliced to one end of the FBG fiber with a first spliced point interposed therebetween, and a second optical fiber that is spliced to the other end of the FBG fiber with a second spliced point interposed therebetween. The optical fiber of the present invention also includes a collectively recoated portion in which at least the FBG fiber, the first spliced point, and the second spliced point are collectively recoated with a recoat resin having a refractive index less than that of silica, the FBG fiber being sandwiched between the first spliced point and the second spliced point.

### TECHNICAL FIELD

The present invention relates to a configuration of an optical fiber used in a fiber laser and, particularly to an optical fiber having a fusion-spliced and recoated structure of a double clad fiber, a fiber laser in which the optical fiber is used, and an optical fiber producing method.

### BACKGROUND ART

A general fiber laser includes a pumping light source, a laser active fiber, and FBG mirrors placed on both sides of the optical fiber to construct a resonator, and each optical fiber is fusion-spliced (for example, see Unexamined Japanese Patent Publication No. 2010-238709).

As to a recoated structure of a fusion-spliced point of a double clad fiber in the fiber laser, a technology of recoating a fusion-spliced point formed by fusion-splicing ends of two optical fibers with a low-refractive-index resin and coating a recoated portion with a reinforcing sleeve and a technology of forming a recoated portion having a substantially conical shape have been proposed (for example, see Unexamined Japanese Patent Publications No. 2009-115918 and No. 2005-010242).

A technology of propagating pumping light to the active fiber with no loss at a high efficiency as much as possible is necessary for an optical circuit configuration of the fiber laser. The technology implements “high light to light conversion efficiency” and “reliability improvement by prevention of light leakage”, and the light having a predetermined optical output is obtained from the fiber laser by inputting a minimum input light (the pumping light), thereby producing a products related to high-reliability optical fiber.

The pumping light loss, which is generated until the pumping light reaches the active fiber since the pumping light propagates through the double clad fiber, is clearly attributed to the following two causes.

First, scattering of the light propagating through the silica fiber is generated in a spliced point in the case that the spliced point of the silica fiber is not smoothed. The light scattering generated by the non-smooth silica fiber can easily be prevented such that the silica fibers having the substantially same diameter are used and spliced.

Second, the scattering of the light propagating through the fiber is generated in a portion in which the spliced point or an FBG write portion is recoated with a low-refractive-index resin.

The recoated resin clad has a weak adhesion to the silica fiber compared with a resin clad that is stably formed during fiber drawing, whereby a micro scattering is generated at an interface. An experiment performed by the inventor shows that the scattering loss of about 1% is generated per length of 20 mm even if a surface of the silica fiber is sufficiently cleaned before the recoating.

In a general fiber laser structure of the conventional technology, an FBG is inserted by the fusion splice between the fiber that introduces the pumping light and the active fiber serving as an active fiber. Accordingly, in the conventional fiber laser structure, the recoated portion of the FBG, the recoated portions of the spliced points at both ends of the FBG exist. However, the viewpoint of minimizing the length of the recoated portion is not described in the conventional technology.

Similarly, in the conventional technology of forming the recoated structure of the fusion-spliced point, a recoat material or a recoat resin shape is improved to suppress the scattering of the pumping light. However, the viewpoint of minimizing the length of the recoated portion is not described in recoating one site of the spliced point. As described in Example 1 of Unexamined Japanese Patent Publication No. 2009-115918, in recoating the one site of the spliced point, the recoated portion is recoated over the length of about 40 mm that is a standard value. Therefore, the viewpoint of minimizing the length of the recoated portion is not described.

### SUMMARY

The present invention provides an optical fiber in which the total length of the recoated portion is minimized to minimize the scattering loss of the pumping light, a fiber laser in which the optical fiber is used, and an optical fiber producing method.

To solve the above problem, an optical fiber of the present invention includes an uncoated FBG fiber in which an FBG mirror is written in a core glass, a first optical fiber that is spliced to one end of the FBG fiber with a first spliced point interposed therebetween, and a second optical fiber that is spliced to the other end of the FBG fiber with a second spliced point interposed therebetween. The optical fiber of the present invention also includes a collectively recoated portion in which at least the FBG fiber, the first spliced point, and the second spliced point are collectively recoated with a recoat resin having a refractive index less than that of silica, the FBG fiber being sandwiched between the first spliced point and the second spliced point.

According to the configuration, the collectively recoated portion can extremely be shortened compared with the case that the original optical fibers to be spliced are separately recoated. The scattering loss amount of the pumping light from collectively recoated portion is minimized, so that the conversion efficiency of the pumping light to the output light can be improved. The three heat radiation components that cool the spliced point and the collectively recoated portion can be collected to the one heat radiation component to contribute to cost reduction of the component and downsizing of the device.

A method for producing the optical fiber of the present invention includes a mirror region forming step, a first splicing step, a second splicing step, and a recoat step. In the mirror region forming step, while a coating of one end of an optical fiber is removed, an FBG mirror is written in a core glass to form a mirror region. In the first splicing step, a first cleaved end is formed by vertically cleaving the optical fiber on an outside of the mirror region and in a region where the coating is removed, and a first spliced point is formed by fusion-splicing a first optical fiber to the first cleaved end. In the second splicing step, a second cleaved end is formed by vertically cleaving the optical fiber on another outside of the mirror region and in a region where the coating is removed, and a second spliced point is formed by fusion-splicing a second optical fiber to the second cleaved end. In the recoat step, at least the mirror region, the FBG fiber, the first spliced point, and the second spliced point are collectively recoated with a recoat resin having a refractive index less than that of silica, the FBG fiber being sandwiched between the first spliced point and the second spliced point.

According to the method, in the produced optical fiber, the collectively recoated portion can extremely be shortened compared with the case that the original optical fibers to be spliced are separately recoated. The scattering loss amount of the pumping light from collectively recoated portion is minimized, so that the conversion efficiency of the pumping light to the output light can be improved.

A fiber laser of the present invention includes a pumping light introduction fiber that propagates pumping light, the optical fiber that includes the FBG mirror, an active fiber, and an optical fiber that includes a low-reflectivity FBG mirror, wherein the active fiber is sandwiched between the FBG mirror and the low-reflectivity FBG mirror to construct a laser resonator.

According to the configuration, the scattering loss amount of the pumping light from collectively recoated portion is minimized, so that the conversion efficiency of the pumping light to the output light can be improved.

### BRIEF DESCRIPTION OF DRAWINGS

FIG. 1 is an entire configuration diagram of a fiber laser in which an optical fiber of the present invention is used.

FIG. 2 is an enlarged sectional view illustrating a detailed configuration of a collectively recoated portion that is a main part of the optical fiber of the present invention.

FIG. 3 is an entire configuration diagram of a comparative example having a conventional configuration for the purpose of comparison with an effect of an example of the fiber laser in which the optical fiber of the present invention is used.

### DESCRIPTION OF EMBODIMENTS

Hereinafter, an embodiment of the present invention will be described with reference to the drawings. In the following drawings, the same structural element is designated by the same reference mark, and sometimes the description is omitted.

### First Exemplary Embodiment

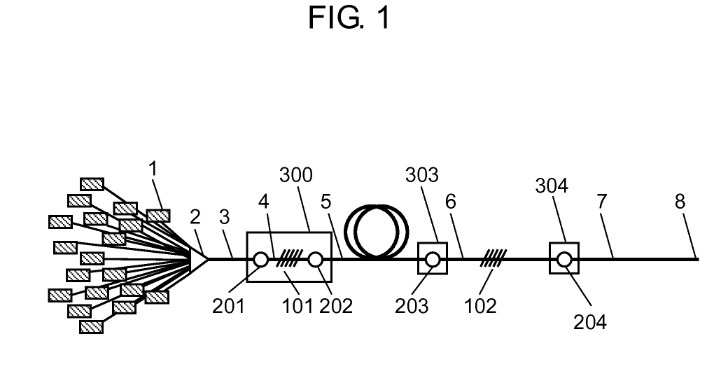

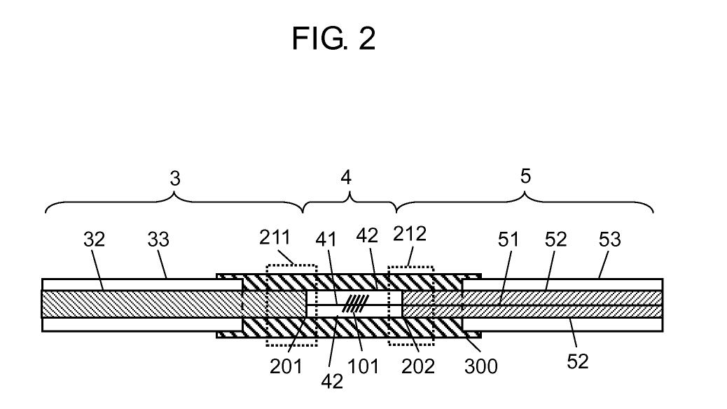

FIG. 1 is an entire configuration diagram of a fiber laser in which an optical fiber of the present invention is used. FIG. 2 is an enlarged sectional view illustrating a detailed configuration of collectively recoated portion 300 that is a main part of the optical fiber of the present invention.

As illustrated in FIG. 1, pumping light beams (not illustrated) emitted from a plurality of pumping laser diodes 1 are introduced to pumping light introduction fiber 3 through pumping light coupler 2. Pumping light introduction fiber 3 is a double clad fiber propagating the pumping light.

Active fiber 5 serving as a double clad fiber is placed. A rare-earth element is added to a core portion of active fiber 5, high-reflection FBG fiber 4 in which high-reflection FBG 101 is written is provided on a pumping light input side of active fiber 5, and low-reflection FBG fiber 6 in which low-reflection FBG 102 is written is provided on the other end. Active fiber 5 is sandwiched between high-reflection FBG fiber 4 and low-reflection FBG fiber 6 to constitute a laser resonator, and active fiber 5 generates a laser oscillation by the input pumping light.

The oscillated laser beam is emitted from low-reflection FBG 102. The laser beam is output from end face 8 through output fiber 7, which is spliced at one end of low-reflection FBG fiber 6 to output the oscillated beam.

The fibers are spliced and recoated in a spliced point.

That is, pumping light introduction fiber 3 and high-reflection FBG fiber 4 are spliced in spliced point 201. High-reflection FBG fiber 4 and active fiber 5 are spliced in spliced point 202. In the fusion, an original coating is removed in a neighborhood of a fusion point between pumping light introduction fiber 3 and high-reflection FBG fiber 4 and a neighborhood of a fusion point between the fibers.

In collectively recoated portion 300, a total length of high-reflection FBG fiber 4, a coating removal portion in the neighborhood of spliced point 201 of pumping light introduction fiber 3, and a coating removal portion in the neighborhood of spliced point 202 of active fiber 5 are collectively recoated with a recoat resin having a refractive index less than that of silica, for example, a silicone resin.

Active fiber 5 and low-reflection FBG fiber 6 are spliced in spliced point 203 and recoated with recoated portion 303. Low-reflection FBG fiber 6 and output fiber 7 are spliced in spliced point 204 and recoated with recoated portion 304.

A detailed configuration of collectively recoated portion 300 in the optical fiber of the first exemplary embodiment will be described with reference to FIG. 2.

As illustrated in FIG. 2, in collectively recoated portion 300 of the optical fiber of the first exemplary embodiment, pumping light introduction fiber 3 and active fiber 5 are fusion-spliced to both ends of uncoated, short, high-reflection FBG fiber 4 in which high-reflection FBG 101 is written as a high-reflection mirror in core 41. Pumping light introduction fiber 3 and high-reflection FBG fiber 4 constitute first spliced point 211 including spliced point 201, and high-reflection FBG fiber 4 and active fiber 5 constitute second spliced point 212 including spliced point 202. Then, high-reflection FBG fiber 4 including high-reflection FBG 101, first spliced point 211 including spliced point 201, and second spliced point 212 including spliced point 202 are coated with a low-refractive-index resin having the refractive index less than or equal to that of silica, cured, and collectively spliced, thereby forming collectively recoated portion 300.

That is, the optical fiber of the first exemplary embodiment includes uncoated FBG fiber 4 in which the FBG mirror is written in the core glass, the first optical fiber (in this case, pumping light introduction fiber 3) spliced to one end of FBG fiber 4 with first spliced point 211 interposed therebetween, and the second optical fiber (in this case, the active fiber 5) spliced to the other end of FBG fiber 4 with the second spliced point 212 interposed therebetween. The optical fiber of the first exemplary embodiment is configured to include collectively recoated portion 300 in which at least FBG fiber 4 and first spliced point 211 and second spliced point 212, between which FBG fiber 4 is sandwiched, are collectively recoated with the recoat resin having the refractive index less than that of silica.

According to the configuration, collectively recoated portion 300 can extremely be shortened compared with the case that the original optical fibers to be spliced are separately recoated. The scattering loss amount of the pumping light from collectively recoated portion 300 is minimized, so that the conversion efficiency of the pumping light to the output light can be improved. The three heat radiation components that cool first spliced point 211, second spliced point 212, and collectively recoated portion 300 can be collected to the one heat radiation component to contribute to the cost reduction of the component and the downsizing of the device.

Generally, in the case that the fibers are spliced with a fiber fusion machine, the fibers cannot be fusion-spliced unless the coating of the ends of fibers is removed by about 20 mm. Accordingly, a coating removal length of 40 mm, namely, a double of each fiber coating removal length of 20 mm is generated at one spliced point.

In the optical fiber of the first exemplary embodiment, the FBG portion supposed to be separately recoated is placed adjacent to the coating removal portion having the length of 20 mm, which is generated in the fusion and inevitably recoated, in recoating. Therefore, the one-time recoating of the fusion and the three-time recoating of the FBG write can be decreased to one-time recoating, and the recoat length can be minimized.

That is, in the optical fiber of the first exemplary embodiment, the two collectively recoated portions and the one post-FBG-write recoated portion are collected to the one recoated portion having the length of about 50 mm, and the recoated portion having the length of about 50 mm is collectively recoated to simultaneously achieve shortening of the recoat length and shortening of a process flow.

In the first exemplary embodiment, the fiber that produces high-reflection FBG fiber 4 includes photosensitive core 41, silica clad 42, and second clad (not illustrated). Photosensitive materials, such as Ge, are added to photosensitive core 41, whereby photosensitive core 41 has a structure in which photosensitive core 41 is operated in a single mode at an oscillation wavelength. Silica clad 42 is a silica glass disposed around core 41, and constitutes a first clad. A second clad is made of a low-refractive-index resin disposed around the first clad. Accordingly, a well-known double clad type photosensitive optical fiber (for example, FUD-3386 fiber produced by Nufern) can be used as the fiber that produces high-reflection FBG fiber 4.

Generally, in the case that high-reflection FBG 101 is written as the high-reflection mirror in core 41 of high-reflection FBG fiber 4, high-reflection FBG 101 is written after the coating of the fiber in which the FBG is written is removed. Therefore, in the first exemplary embodiment, advantageously high-reflection FBG fiber 4 in the coating removal state can directly be used, and the cost of recoating the FBG write portion can be reduced.

Low-reflection FBG fiber 6 has the same configuration as high-reflection FBG fiber 4. However, low-reflection FBG fiber 6 is recoated after the FBG is written in the coating removal state.

Pumping light introduction fiber 3 has a structure in which the photosensitive core glass is removed from high-reflection FBG fiber 4. Therefore, pumping light introduction fiber 3 includes silica core 32 made of the silica glass and low-refractive-index coating resin 33 disposed around silica core 32. Generally the same fiber as high-reflection FBG fiber 4 may be used as pumping light introduction fiber 3 by ignoring existence of the photosensitive core glass of high-reflection FBG fiber 4.

A rare-earth-element-doped core double clad fiber (for example, SM-YDF-7/210 fiber produced by Nufern) having the core portion doped with rare-earth elements, such as Yb can be used as active fiber 5. Active fiber 5 includes core 51 with which the rare-earth element is doped, silica clad 52, which is the silica glass disposed around core 51 and constitutes the first clad, and coating resin 53, which is disposed around silica clad 52 and is the second clad made of the low-refractive-index resin.

As illustrated in FIG. 2, coating resin 33 is removed in the neighborhood of spliced point 201 of pumping light introduction fiber 3. Coating resin 53 is removed in the neighborhood of spliced point 202 of active fiber 5. Collectively recoated portion 300 is formed by collectively recoating the whole region including the neighborhood of spliced point 201 of pumping light introduction fiber 3, the neighborhood of spliced point 202 of active fiber 5, and the high-reflection FBG fiber with the recoat resin having the refractive index less than that of silica.

That is, the optical fiber of the first exemplary embodiment includes the FBG fiber 4, a first optical fiber (in this case, the pumping light introduction fiber 3), and a second optical fiber (in this case, the active fiber 5). FBG fiber 4 is the uncoated fiber in which the FBG mirror is written in the core glass. The first optical fiber is spliced to one end of FBG fiber 4 with first spliced point 211 interposed therebetween. The second optical fiber is spliced to the other end of the FBG fiber with second spliced point 212 interposed therebetween. The optical fiber of the first exemplary embodiment is configured to include collectively recoated portion 300 in which at least FBG fiber 4 and first spliced point 211 and second spliced point 212, between which FBG fiber 4 is sandwiched, are collectively recoated with the recoat resin having the refractive index less than that of silica.

According to the configuration, collectively recoated portion 300 can extremely be shortened compared with the case that the original optical fibers to be spliced are separately recoated. The scattering loss amount of the pumping light from collectively recoated portion 300 is minimized, so that the conversion efficiency of the pumping light to the output light can be improved. The three heat radiation components that cool spliced points 211 and 212 and collectively recoated portion 300 can be collected to the one heat radiation component to contribute to the cost reduction of the component and the downsizing of the device.

Output fiber 7 of the first exemplary embodiment is a silica fiber spliced to high-reflection FBG fiber 4, active fiber 5, and low-reflection FBG fiber 6 in FIG. 1 with low loss. Generally the same fiber as high-reflection FBG fiber 4 or low-reflection FBG fiber 6 can be used as output fiber 7.

In such cases, a resin having a refractive index greater than that of silica is used as recoated portion 304 of spliced point 204 between low-reflection FBG fiber 6 and output fiber 7 and, preferably the residual pumping light is removed from the fiber by leaking pumping light to the resin.

In order to make the fusion-spliced and recoated structure of the optical fiber of the first exemplary embodiment, it is necessary to minimize the length of the recoated portion as much as possible. Therefore, it is necessary to shorten high-reflection FBG fiber 4, in which the coating is removed, as much as possible. Specifically, the effect of the present invention can clearly be confirmed by shortening both sides of high-reflection FBG fiber 4 around high-reflection FBG 101 by 10 mm or less (the total length of 20 mm or less).

In high-reflection FBG fiber 4, the first optical fiber is spliced to a cleaved end (in this case, spliced point 201) that is formed by vertically cleaving an outside of the mirror region where FBG mirror (in this case, the high-reflection FBG) is written. Uncoated, short FBG fiber 4 may be constructed by fusing the second optical fiber to the cleaved end (in this case, spliced point 202) that is formed by vertically cleaving another outside of the mirror region.

Because collectively recoated portion 300 can extremely shortened by the configuration, the scattering loss amount of the pumping light from collectively recoated portion 300 is minimized. Therefore, the conversion efficiency of the pumping light to the output light can further be improved.

However, high-reflection FBG fiber 4 cannot be set in the fusion machine when high-reflection FBG fiber 4 is cut into several millimeters from the beginning. Therefore, one of the features of the present invention is that high-reflection FBG fiber 4 is dealt with while another optical fiber is always fusion-spliced to one end of high-reflection FBG fiber 4.

Specifically, before the shortening, high-reflection FBG fiber 4 is vertically cleaved at a position several-millimeter distant from the portion in which high-reflection FBG 101 is formed, and active fiber 5 is fusion-spliced to the cleaved end, for example, spliced point 202 by an optimum core alignment method, thereby forming first spliced point 211. Then the opposite side with respect to high-reflection FBG 101 is dealt with in the same manner, high-reflection FBG fiber 4 is vertically cleaved at the position several-millimeter distant from high-reflection FBG 101, and pumping light introduction fiber 3 is spliced to the cleaved end, for example, spliced point 201 to form second spliced point 212, thereby shortening high-reflection FBG fiber 4.

That is, the method for producing the optical fiber of the first exemplary embodiment includes a mirror region forming step, a first splicing step, a second splicing step, and a recoat step. In the mirror region forming step, while the coating of one end of the optical fiber is removed, the FBG mirror (in this case, high-reflection FBG 101) is written in the core glass to form the mirror region. In the first splicing step, a first cleaved end (in this case, spliced point 201) is formed by vertically cleaving the optical fiber (in this case, high-reflection FBG fiber 4) on the outside of the mirror region and in the region where the coating is removed, and the first optical fiber (in this case, pumping light introduction fiber 3) is fusion-spliced to the first cleaved end to form first spliced point 211. In the second splicing step, a second cleaved end (in this case, spliced point 202) is formed by vertically cleaving the optical fiber (in this case, high-reflection FBG fiber 4) on another outside of the mirror region and in the region where the coating is removed, and the second optical fiber (in this case, active fiber 5) is fusion-spliced to the second cleaved end to form second spliced point 212. In the recoat step, at least the mirror region, FBG fiber 4, and first spliced point 211 and second spliced point 212, between which FBG fiber 4 is sandwiched, are collectively recoated with the recoat resin having the refractive index less than that of silica.

In the optical fiber produced by the above method, collectively recoated portion 300 can extremely be shortened compared with the case that the original optical fibers to be spliced are separately recoated. The scattering loss amount of the pumping light from collectively recoated portion 300 is minimized, so that the conversion efficiency of the pumping light to the output light can be improved.

In this case, the recoat length is a sum of the total length of FBG fiber 4 shortened to several millimeters and the coating removal length of about 20 mm at each of leading ends of pumping light introduction fiber 3 and active fiber 5, in which the coatings are removed for the purpose of the fusion, and the recoat length can be shortened to about 60 mm or less at the longest.

Preferably collectively recoated portion 300 is recoated with the same low-refractive-index resin (for example, OP-38Z produced by Dainippon Ink And Chemicals, Incorporated) as pumping light introduction fiber 3 or active fiber 5, and collectively recoated portion 300 is accommodated in a metallic case to radiate heat generated by the leakage light.

The fiber laser of the first exemplary embodiment includes pumping light introduction fiber 3 propagating the pumping light beam, the optical fiber (in this case, high-reflection FBG fiber 4) including the FBG mirror (in this case, high-reflection FBG 101), the active fiber (in this case, active fiber 5), and the optical fiber (in this case, low-reflection FBG fiber 6) including the low-reflectivity FBG mirror. In the fiber laser of the first exemplary embodiment, the laser resonator is constructed by sandwiching the active fiber between the FBG mirror and the low-reflectivity FBG mirror (in this case, low-reflection FBG 102).

The scattering loss amount of the pumping light from collectively recoated portion 300 is minimized by the configuration, so that the conversion efficiency of the pumping light to the output light can be improved.

A cross-sectional surface of the first clad of the double clad fiber used in the present invention is not limited to a circular shape, but the same effect is obtained even if non-circular shapes, such as an ellipse, a polygon, and a D-shape, are used as the cross-sectional surface of the first clad.

The recoat resin used in the present invention is not limited to an ultraviolet curable acrylate resin, but the same effect is obtained even if a low-refractive-index silicone resin is used. The low-refractive-index silicone resin is relatively easy to deal with.

In the fiber laser, the use of the collectively recoated structure of the present invention effectively provides the pumping light to the active fiber to improve the conversion efficiency of the pumping light to the oscillation output light.

At least one of the first optical fiber and the second optical fiber may be constructed by the double clad fiber having the core portion doped with the rare-earth element. According to the configuration, the FBG fiber and the active fiber can collectively be recoated to extremely shorten the collectively recoated portion. The scattering loss amount of the pumping light from collectively recoated portion is minimized, so that the conversion efficiency of the pumping light to the output light can be improved.

Alternatively, the FBG mirror written in the FBG fiber is the high-reflection FBG mirror, and at least one of the first optical fiber and the second optical fiber may be constructed by the double clad fiber that propagates the pumping light exciting the rare-earth element. According to the configuration, the FBG fiber and the pumping light introduction fiber can collectively be recoated to extremely shorten the collectively recoated portion. The scattering loss amount of the pumping light from collectively recoated portion is minimized, so that the conversion efficiency of the pumping light to the output light can be improved.

The recoat resin may be the silicone resin having the refractive index less than that of silica. According to the configuration, the collectively recoated portion is further easily formed and the conversion efficiency of the pumping light to the output light can be improved.

The collectively recoated portion may linearly be disposed and accommodated in a heat radiation metallic component. According to the configuration, the length of the collectively recoated portion can be minimized to improve the conversion efficiency of the pumping light to the output light.

### EXAMPLE

An experiment was specifically performed as an example using the fiber laser and optical fiber of the first exemplary embodiment having the configurations in FIGS. 1 and 2. The detailed example and a measurement result of pumping light transmittance are described below.

19 laser diodes of L4-9891510-100C produced by JDSU were used as pumping laser diode 1, and a 19×1 combiner produced of Lightcomm was used as pumping light coupler 2.

A FUD-3386 fiber produced by Nufern was used as pumping light introduction fiber 3, high-reflection FBG fiber 4 that was shortened while the coating was removed, low-reflection FBG fiber 6, and output fiber 7.

A SM-YDF-7/210 fiber (produced by Nufern) of 50 m was used as active fiber 5 while wound around an aluminum reel of φ150 mm to radiate the heat.

High-reflection FBG fiber 4 that was shortened while the coating was removed had the total length of 15 mm, and collectively recoated portion 300 has the length of 55 mm. A center wavelength of the FBG was set to 1090 nm.

OF-182 produced by Shin-Etsu Chemical Co., Ltd was used as the high-refractive-index silicone resin for recoated portion 304 coating spliced point 204 between output fiber 7 and low-reflection FBG fiber, and the residual pumping light was removed.

The optical circuit in FIG. 1 was formed using the above components, pumping laser diode 1 was oscillated with a current of 10 A to excite active fiber 5, and the fiber laser was oscillated. As a result, the output light of 115 W was obtained.

When the optical output was measured in each region while the optical circuit was taken apart by cut back, the pumping light having intensity of 190 W was obtained immediately below collectively recoated portion 300.

The intensity of 194 W was obtained when the output of the pumping light was measured in the middle of the pumping light introduction fiber 3.

As described above, it was checked that the pumping light transmittance of collectively recoated portion 300 was (190 W/194 W)×100=about 97.9%.

It was checked that the oscillation efficiency was (115 W/190 W)×100=about 60.5%. Only one component of 10 mm×10 mm×60 mm was used as the heat radiation component in the recoated portion.

From the experimental result, it is considered that the conversion efficiency of the pumping light to the output light can be improved because the collectively recoated portion 300 is extremely shortened to minimize the scattering loss amount of the pumping light from collectively recoated portion 300. The three heat radiation components that cool collectively recoated portion 300 can be collected to the one heat radiation component to contribute to the cost reduction of the component and the downsizing of the device.

### Comparative Example

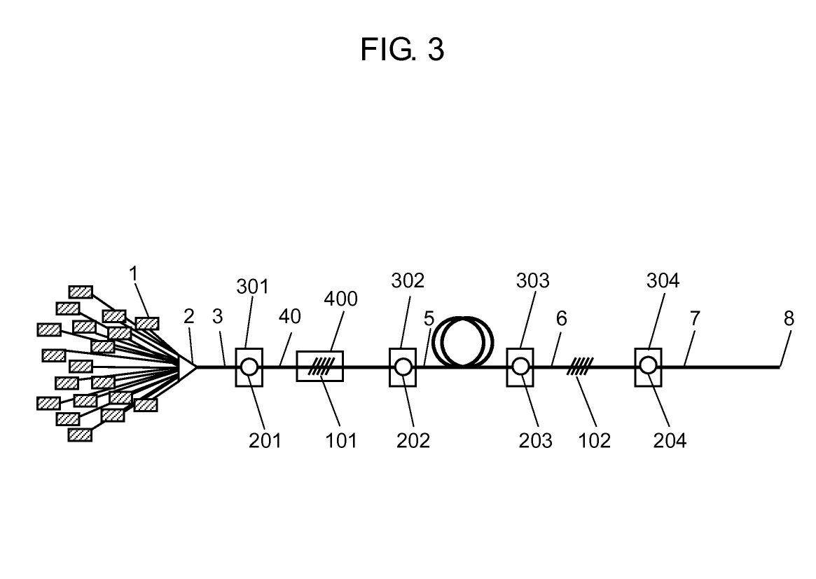

A fiber laser corresponding to the conventional technology was constructed and compared to the effect of the above example. FIG. 3 illustrates a configuration of the fiber laser corresponding to the conventional technology. FIG. 3 is an entire configuration diagram of a comparative example having the conventional configuration.

In FIG. 3, collectively recoated portion 300 in FIG. 1 is replaced as follows.

High-reflection FBG fiber 40 is directly recoated and used after high-reflection FBG 101 is written as the high-reflectance mirror. The shortening is not performed unlike the characteristic configuration of the present invention. The recoated portion 400 had the length of about 20 mm.

Pumping light introduction fiber 3 and high-reflection FBG fiber 40 are spliced in spliced point 201, and recoated in recoated portion 301. The recoated portion 301 had the length of about 40 mm. High-reflection FBG fiber 40 and active fiber 5 are spliced in spliced point 202, and recoated in recoated portion 302. Recoated portion 302 had the length of about 40 mm.

As described above, recoated portion 301 in spliced point 201 between pumping light introduction fiber 3 and high-reflection FBG fiber 40 has the recoat length of about 40 mm. Recoated portion 302 in spliced point 202 between high-reflection FBG fiber 40 and active fiber 5 has the recoat length of about 40 mm, and recoated portion 400 of high-reflection FBG 101 has the recoat length of about 20 mm. Accordingly, as illustrated in FIG. 3, the total number of three recoated portions exists between pumping light introduction fiber 3 and active fiber 5, and the total of recoat lengths reaches about 100 mm.

The same optical fiber and optical component as those of Example 1 in FIG. 1 were used. In the fiber laser having the above configuration, when pumping laser diode 1 was oscillated with the current of 10 A to oscillate the fiber laser, the output light of 109 W was obtained.

When the optical output was measured in each region while the optical circuit was taken apart by cut back, the pumping light having the intensity of 184 W was obtained immediately below recoated portion 302 of spliced point 202 between high-reflection FBG fiber 40 and active fiber 5.

The intensity of 194 W was obtained when the output of the pumping light was measured in the middle of the pumping light introduction fiber 3.

It was checked that the pumping light transmittance was (184 W/194 W)×100=about 94.8% at each of three recoated portions 301, 400, and 302. Because the pumping light transmittance of the first exemplary embodiment is about 97.9%, it is found that the pumping light transmittance is degraded by about 3% in the comparative example.

It was checked that the oscillation efficiency was (109 W/184 W)×100=about 59.2%. Because the oscillation efficiency of the first exemplary embodiment is about 60.5%, it is found that the oscillation efficiency is degraded by about 1.3% in the comparative example.

In the comparative example, three recoated portions 301, 302, and 400 have the lengths of about 40 mm, about 20 mm, and about 40 mm, and recoated portions 301, 302, and 400 are separated from one another. Accordingly, it is necessary to provide the three heat radiation components of 10 mm×10 mm×60 mm in recoated portions 301, 302, and 400.

As described above, the conversion efficiency of the pumping light to the output light was improved by minimizing the recoat length. The three heat radiation components that cool fusion-spliced point and the recoated portion were able to be collected to the one heat radiation component to contribute to the cost reduction of the component and the downsizing of the device.

The optical fiber of the present invention improves the propagation efficiency of the light propagating through the double clad fiber, and the optical fiber is useful to the fusion-spliced and recoated structure of the optical fiber used in the fiber laser.

What is claimed is:

1. An optical fiber comprising:
a FBG fiber which is uncoated and in which an FBG mirror is written in a core glass;
a first optical fiber that is spliced to one end of the FBG fiber with a first spliced point interposed therebetween;
a second optical fiber that is spliced to the other end of the FBG fiber with a second spliced point interposed therebetween; and
a collectively recoated portion in which at least the FBG fiber, the first spliced point, and the second spliced point are collectively recoated with a recoat resin having a refractive index less than that of silica, the FBG fiber being sandwiched between the first spliced point and the second spliced point.

2. The optical fiber according to claim 1,
wherein the FBG fiber is shortened by fusing the first optical fiber to a cleaved end, which is formed by vertically cleaving an outside of a mirror region where the FBG mirror is written, and by fusing the second optical fiber to a cleaved end, which is formed by vertically cleaving another outside of the mirror region.

3. The optical fiber according to claim 1,
wherein at least one of the first optical fiber and the second optical fiber is constructed by a double clad fiber having a core portion doped with a rare-earth element.

4. The optical fiber according to claim 2,
wherein at least one of the first optical fiber and the second optical fiber is constructed by a double clad fiber having a core portion doped with a rare-earth element.

5. The optical fiber according to claim 1,
wherein the FBG mirror written in the FBG fiber is a high-reflection FBG mirror, and at least one of the first optical fiber and the second optical fiber is constructed by a double clad fiber that propagates pumping light exciting a rare-earth element.

6. The optical fiber according to claim 2,
wherein the FBG mirror written in the FBG fiber is a high-reflection FBG mirror, and at least one of the first optical fiber and the second optical fiber is constructed by a double clad fiber that propagates pumping light exciting a rare-earth element.

7. The optical fiber according to claim 1,
wherein the recoat resin is a silicone resin having a refractive index less than that of silica.

8. The optical fiber according to claim 2,
wherein the recoat resin is a silicone resin having a refractive index less than that of silica.

9. The optical fiber according to claim 1,
wherein the collectively recoated portion is linearly disposed and accommodated in a heat radiation metallic component.

10. The optical fiber according to claim 2,
wherein the collectively recoated portion is linearly disposed and accommodated in a heat radiation metallic component.

11. An optical fiber manufacturing method comprising:
a mirror region forming step of, while a coating of one end of an FBG fiber is removed, writing an FBG mirror in a core glass to form a mirror region;
a first splicing step of forming a first cleaved end by vertically cleaving the optical fiber on an outside of the mirror region and in a region where the coating is removed, and forming a first spliced point by fusion-splicing a first optical fiber to the first cleaved end;
a second splicing step of forming a second cleaved end by vertically cleaving the optical fiber on another outside of the mirror region and in a region where the coating is removed, and forming a second spliced point by fusion-splicing a second optical fiber to the second cleaved end; and
a recoat step of collectively recoating at least the mirror region, the FBG fiber, the first spliced point, and the second spliced point with a recoat resin having a refractive index less than that of silica, the FBG fiber being sandwiched between the first spliced point and the second spliced point.

12. A fiber laser comprising:
a pumping light introduction fiber that propagates pumping light;
the optical fiber according to claim 1 that includes the FBG mirror;
an active fiber; and
an optical fiber that includes a low-reflectivity FBG mirror,
wherein the active fiber is sandwiched between the FBG mirror and the low-reflectivity FBG mirror to construct a laser resonator.

13. A fiber laser comprising:
a pumping light introduction fiber that propagates pumping light;
the optical fiber according to claim 2 that includes the FBG mirror;
an active fiber; and
an optical fiber that includes a low-reflectivity FBG mirror,
wherein the active fiber is sandwiched between the FBG mirror and the low-reflectivity FBG mirror to construct a laser resonator.

14. A fiber laser comprising:
a pumping light introduction fiber that propagates pumping light;
the optical fiber according to claim 3 that includes the FBG mirror;
an active fiber; and
an optical fiber that includes a low-reflectivity FBG mirror,
wherein the active fiber is sandwiched between the FBG mirror and the low-reflectivity FBG mirror to construct a laser resonator.

15. A fiber laser comprising:
a pumping light introduction fiber that propagates pumping light;
the optical fiber according to claim 4 that includes the FBG mirror;
an active fiber; and
an optical fiber that includes a low-reflectivity FBG mirror,
wherein the active fiber is sandwiched between the FBG mirror and the low-reflectivity FBG mirror to construct a laser resonator.

16. A fiber laser comprising:
a pumping light introduction fiber that propagates pumping light;
the optical fiber according to claim 5 that includes the FBG mirror;
an active fiber; and
an optical fiber that includes a low-reflectivity FBG mirror,
wherein the active fiber is sandwiched between the FBG mirror and the low-reflectivity FBG mirror to construct a laser resonator.
